(19) United States
(12) Patent Application Publication
(10) Pub. No.: US 2024/0267570 A1
(43) Pub. Date: Aug. 8, 2024

(54) VIRTUAL LIVE STREAMING METHOD AND APPARATUS

(71) Applicant: SHANGHAI BILIBILI TECHNOLOGY CO., LTD., Shanghai (CN)

(72) Inventors: Huaizhou ZHANG, Shanghai (CN); Shaoxiong GUO, Shanghai (CN); Yang MING, Shanghai (CN)

(21) Appl. No.: 18/400,898

(22) Filed: Dec. 29, 2023

(30) Foreign Application Priority Data
Dec. 30, 2022 (CN) 202211742403.4

(51) Int. Cl. H04N 21/2187; G06V 40/16; G06V 40/20

(52) U.S. Cl. CPC H04N 21/2187; G06V 40/174; G06V 40/23

(57) ABSTRACT

The present application provides techniques for virtual live streaming. The techniques comprise loading at least two virtual images in a current live streaming room in response to a request for adding the at least two virtual images; generating a unique identifier corresponding to each of the at least two virtual images while loading each of the at least two virtual images; obtaining motion capture data indicative of motions to be applied in the current live streaming room; and performing virtual live streaming in the current live streaming room based on the at least two virtual images and the motion capture data.

### CROSS-REFERENCE TO RELATED APPLICATION

The present application claims priority to Chinese Patent Application No. 202211742403.4, filed on Dec. 30, 2022, which is incorporated herein by reference in its entirety.

### TECHNICAL FIELD

The present application relates to the field of computer technologies, and in particular, to a live streaming method and apparatus, a computing device, and a storage medium.

### BACKGROUND ART

With the development of computer technologies, live streaming and other services have become popular network services at present. In living streaming, an online streamer may not want to show his or her real images for various reason. Improvements in living streaming are desired.

### SUMMARY OF THE INVENTION

An objective of the present application is to provide a virtual live streaming method and apparatus, a computing device, and a storage medium, to resolve a technical problem that currently, only one virtual image can be loaded in a single live streaming room, and virtual live streaming is implemented in a simple way, making it difficult to improve user experience in the live streaming room.

An aspect of embodiments of the present application provides a virtual live streaming method, including: in response to a request for adding at least two virtual images, loading the virtual images in a current live streaming room; obtaining motion capture data for the current live streaming room; and performing virtual live streaming in the current live streaming room based on the motion capture data and the virtual images.

Optionally, after the loading the virtual images in a current live streaming room, the method further includes: configuring each of the virtual images for live streaming; and the performing virtual live streaming in the current live streaming room based on the motion capture data and the virtual images comprises: performing virtual live streaming in the current live streaming room based on the motion capture data, the configuration for live streaming, and the virtual images.

Optionally, the configuring each of the virtual images for live streaming includes: configuring a different motion capture device for each of the virtual images, where the motion capture device is configured to obtain the motion capture data.

Optionally, the loading the virtual images in a current live streaming room includes: generating a unique identifier corresponding to each of the virtual images when the virtual image is loaded; and storing each of the virtual images and the unique identifier corresponding to the virtual image by using a hash table.

Optionally, the configuring each of the virtual images for live streaming includes: selecting a target virtual image to obtain the unique identifier corresponding to the target virtual image, where the target virtual image is any one of the virtual images; obtaining a configuration option corresponding to the target virtual image based on the unique identifier corresponding to the target virtual image; and configuring the target virtual image for live streaming according to an input instruction for the configuration option.

Optionally, the performing virtual live streaming in the current live streaming room based on the motion capture data, the configuration for live streaming, and the virtual images includes: in a case that the configuration of the target virtual image for live streaming is updated, refreshing rendering of the target virtual image based on the motion capture data and the updated configuration for live streaming.

Optionally, the configuration for live streaming includes a configuration for a facial expression, and the configuration for a facial expression is used to drive the virtual image to make a preset facial expression motion according to a preset instruction; and the performing virtual live streaming in the current live streaming room based on the motion capture data, the configuration for live streaming, and the virtual images includes: in a case that the target virtual image is configured with the facial expression and the preset instruction is received, driving the target virtual image to make the preset facial expression motion, where the target virtual image is any one or more of the virtual images.

Optionally, the preset facial expression motion includes switching the target virtual image to a preset virtual image.

Optionally, the configuration for live streaming is used to enable or disable inputting of the motion capture data to the virtual image; and the performing virtual live streaming in the current live streaming room based on the motion capture data, the configuration for live streaming, and the virtual images includes: in a case that the configuration of the target virtual image for live streaming is disabled, disabling the inputting of the motion capture data to the target virtual image, where the target virtual image is any one of the virtual images; and performing virtual live streaming in the current live streaming room based on the motion capture data, the configuration for live streaming, and virtual images other than the target virtual image.

An aspect of the embodiments of the present application further provides a virtual live streaming apparatus, including: a loading module configured to: in response to a request for adding at least two virtual images, load the virtual images in a current live streaming room; an obtaining module configured to obtain motion capture data for the current live streaming room; and a live streaming module configured to perform virtual live streaming in the current live streaming room based on the motion capture data, the configuration for live streaming, and the virtual images.

An aspect of the embodiments of the present application further provides a computing device, including a memory, a processor, and a computer program stored in the memory and executable on the processor, where the processor, when executing the computer program, is configured to implement the steps of the above virtual live streaming method.

An aspect of the embodiments of the present application further provides a computer-readable storage medium, storing a computer program, where the computer program may be executed by at least one processor to cause the at least one processor to perform the steps of the above virtual live streaming method.

The virtual live streaming method and apparatus, the computing device, and the storage medium provided in the embodiments of the present application have the following advantages:

The at least two virtual images are loaded in the current live streaming room in response to the request for adding the at least two virtual images; the motion capture data for the current live streaming room is obtained; and virtual live streaming is performed in the current live streaming room based on the motion capture data and the virtual images. In this method, a plurality of virtual images can be loaded in a single live streaming room and virtual live streaming is performed by using the plurality of virtual images, thereby enriching implementation forms of virtual live streaming, and improving user experience in the live streaming room while reducing costs for virtual streamers to perform virtual live streaming using virtual live streaming technologies.

### BRIEF DESCRIPTION OF THE DRAWINGS

FIG. 1 is a diagram schematically showing an architecture of an environment according to an embodiment of the present application;

FIG. 2 is a flowchart schematically showing a virtual live streaming method according to Embodiment 1 of the present application;

FIG. 3 is a flowchart of sub-steps of step S310 in FIG. 2;

FIG. 4 is a diagram of an example of a scenario in which a virtual image is configured for live streaming;

FIG. 5 is a flowchart of configuring each virtual image for live streaming in a virtual live streaming method;

FIG. 6 is a diagram of another example of a scenario in which a virtual image is configured for live streaming;

FIG. 7 is a diagram of still another example of a scenario in which a virtual image is configured for live streaming;

FIG. 8 is a diagram of still another example of a scenario in which a virtual image is configured for live streaming;

FIG. 9 is a diagram of still another example of a scenario in which a virtual image is configured for live streaming;

FIG. 10 is a flowchart of sub-steps of step S330 in FIG. 2;

FIG. 11 is a diagram of still another example of a scenario in which a virtual image is configured for live streaming;

FIG. 12 is a diagram of still another example of a scenario in which a virtual image is configured for live streaming;

FIG. 13 is an example flowchart of a virtual live streaming method;

FIG. 14 is a block diagram schematically showing a virtual live streaming apparatus according to Embodiment 2 of the present application; and

FIG. 15 is a diagram schematically showing a hardware architecture of a computing device according to Embodiment 3 of the present application.

### DETAILED DESCRIPTION OF EMBODIMENTS

To make the objectives, technical solutions, and advantages of the present application clearer and more comprehensible, the present application is further described in detail with reference to the accompanying drawings and embodiments. It should be understood that the specific embodiments described herein are merely intended to explain the present application, and are not intended to limit the present application. All other embodiments obtained by a person of ordinary skill in the art based on the embodiments of the present application without creative efforts shall fall within the protection scope of the present application.

It should be noted that the descriptions related to “first”, “second”, and the like in the embodiments of the present application are merely used for the illustrative purpose, and should not be construed as indicating or implying the relative importance thereof or implicitly indicating the number of technical features indicated. Therefore, a feature defined by “first” or “second” may explicitly or implicitly include at least one such feature. In addition, technical solutions in various embodiments may be combined with each other, provided that they can be implemented by a person of ordinary skill in the art. When a combination of the technical solutions incurs conflict or cannot be implemented, it should be considered that such a combination of the technical solutions does not exist, and does not fall within the claimed scope of protection of the present application either.

In the description of the present application, it should be understood that, the reference numerals of steps do not indicate the order of execution of the steps, but are merely to facilitate the description of the present application and differentiation between the steps, and thus are not interpreted as limiting the present application.

Terms in the present application are explained below.
live2d: a software technology that allows a user to create dynamic expressions that breathe life into original 2D illustrations.
Hash table: also known as a hash map, is a data structure that is directly accessed based on a key value. A record is accessed by mapping a key value to a position in the table to speed up a search.

Globally Unique Identifier (GUID): a unique identifier generated by an algorithm, and typically represented as a character string of 32 hexadecimal digits (0-9, A-F), for example, {21EC2020-3AEA-1069-A2DD-08002B30309D}, which is essentially a 128-bit binary integer.

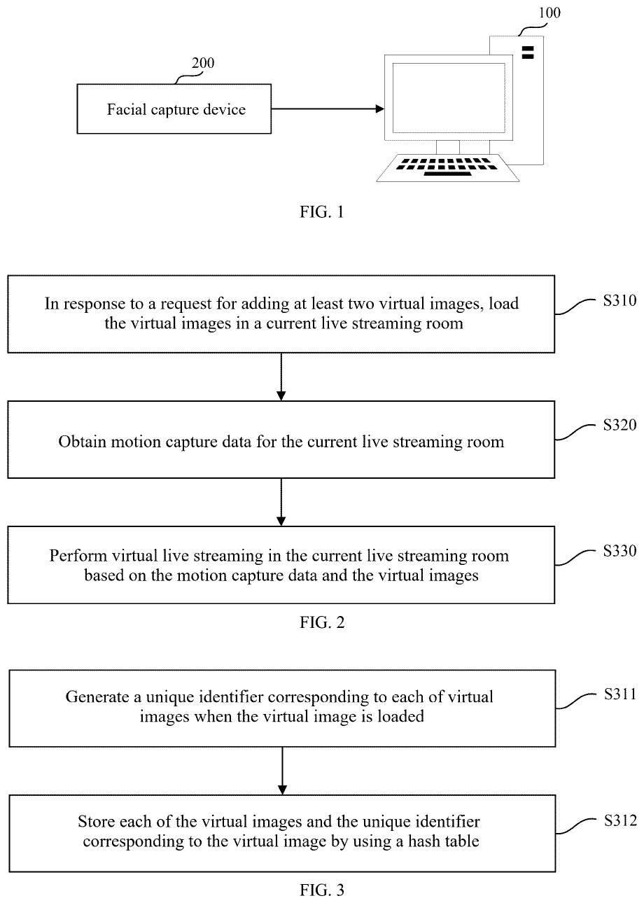

FIG. 1 is a diagram schematically showing an architecture of an environment according to an embodiment of the present application. As shown in the figure:

A motion capture device 200 is connected to a client 100, and may be configured to obtain motion capture data of a streamer in a live streaming room. The client 100 may obtain the motion capture data from the motion capture device 200. The client 100 may make a request for adding a virtual image for a user (a virtual streamer) to load a corresponding virtual image in a current live streaming room, and perform virtual live streaming in the current live streaming room based on the obtained motion capture data and two or more virtual images. Virtual live streaming (i.e., AR live streaming), in contrast to real-scene live streaming, is a new type of live streaming method that integrates virtuality and reality. For example, virtual images such as simulated human streamer characters and cartoon characters are used to replace actual characters of human streamers for live streaming.

In an exemplary embodiment, the client 100 may include a mobile device, a tablet device, a laptop computer, an intelligent device (for example, intelligent clothing, a smart watch, or smart glasses), virtual reality headphones, a gaming device, a set-top box, a digital streaming device, a robot, a vehicle-mounted terminal, a smart television, a television box, or an e-book reader. Optionally, the client 100 may alternatively be a server. The server may be an independent server or a cluster composed of a plurality of servers.

The motion capture device 200 may include an input source, specifically including a real camera input source such as a camera, a video camera, and a laser scanner, or a virtual camera input source. Optionally, the input source of the motion capture device 200 may alternatively be a video source, a picture source, or the like. In addition, the motion capture device 200 may further include modules for storage, sending, reading, and the like of data to transmit the motion capture data to the client 100.

In the related art, in the virtual live streaming technologies, only one virtual image can be loaded in a single live streaming room, and virtual live streaming is implemented in a simple way, making it difficult to improve user experience in the live streaming room.

In the virtual live streaming method in the embodiments of the present application, two or more virtual images may be loaded in a single live streaming room to enrich implementation forms of virtual live streaming, thereby improving user experience in the live streaming room.

The following describes virtual live streaming solutions in the embodiments of the present application through several embodiments. For ease of understanding, an example in which the client 100 in FIG. 1 is an execution body is used for description.

### Embodiment 1

FIG. 2 is a flowchart schematically showing a virtual live streaming method according to Embodiment 1 of the present application. The method may include steps S310 to S330 specifically as follows.

In step S310, in response to a request for adding at least two virtual images, the virtual images are loaded in a current live streaming room.

Specifically, a virtual streamer (that is, a streaming user) in the current live streaming room may perform an operation for the client 100 to input the request for adding the virtual image. After receiving the adding request, the client 100 responds to the adding request and loads two or more virtual images in the current live streaming room based on the request. The client 100 may load the virtual image in the current live streaming room based on a virtual live streaming technology, for example, load a corresponding virtual image based on a live2d technology. It should be noted that live2d is a technology for 2D virtual live streaming, and other technologies for 2D or 3D virtual live streaming may also be used actually. This is not specifically limited herein.

In an exemplary embodiment, as shown in FIG. 3, step S310 may include steps S311 and S312.

In step S311, a unique identifier corresponding to each of the virtual images is generated when the virtual image is loaded.

The unique identifier may be a GUID, specifically, a corresponding GUID that is generated for a currently loaded virtual image based on a GUID algorithm when the virtual image is loaded. For example, if a virtual image A is loaded, a GUID A corresponding to the virtual image A may be generated based on the GUID algorithm.

In step S312, each of the virtual images and the unique identifier corresponding to the virtual image are stored by using a hash table.

For example, each of the virtual images and the unique identifier corresponding to the virtual image such as the virtual image A-GUID A, the virtual image B-GUID B, and the like may be stored by using the hash table. This facilitates subsequently obtaining a corresponding unique identifier based on the virtual image, effectively managing the virtual images, and speeding up data search.

In this embodiment, when each virtual image is loaded, the unique identifier corresponding to the virtual image is generated, and each virtual image and the unique identifier corresponding to the virtual image are stored by using the hash table. This facilitates effectively managing the virtual images and improving management efficiency and data query efficiency.

In step S320, motion capture data for the current live streaming room is obtained.

The motion capture data may include, but not limited to, facial motion capture data and body motion capture data. When 2D virtual live streaming is performed, the motion capture data may be the facial motion capture data, while when 3D virtual live streaming is performed, the motion capture data may be the facial motion capture data and the body motion capture data.

Obtaining the motion capture data for the current live streaming room may be obtaining motion capture data of the user for which the virtual image is loaded by using the virtual live streaming technology. Because virtual live streaming is generally performed by a virtual streamer in a live streaming room, obtaining the motion capture data for the current live streaming room may also mean obtaining motion capture data for the virtual streamer.

Specifically, the motion capture data of the user may be collected by the motion capture device 200 shown in FIG. 1 and the collected motion capture data may be inputted into the client 100, so that the client 100 may obtain the corresponding motion capture data.

In step S330, virtual live streaming is performed in the current live streaming room based on the motion capture data and the virtual images.

Performing virtual live streaming may be performing virtual live streaming in the current live streaming room based on the motion capture data obtained in real time and all loaded virtual images. Optionally, before virtual live streaming is performed, the virtual image may be configured accordingly to meet requirements of the user for live streaming. Certainly, a default configuration may alternatively be used for virtual live streaming. This is not specifically limited herein.

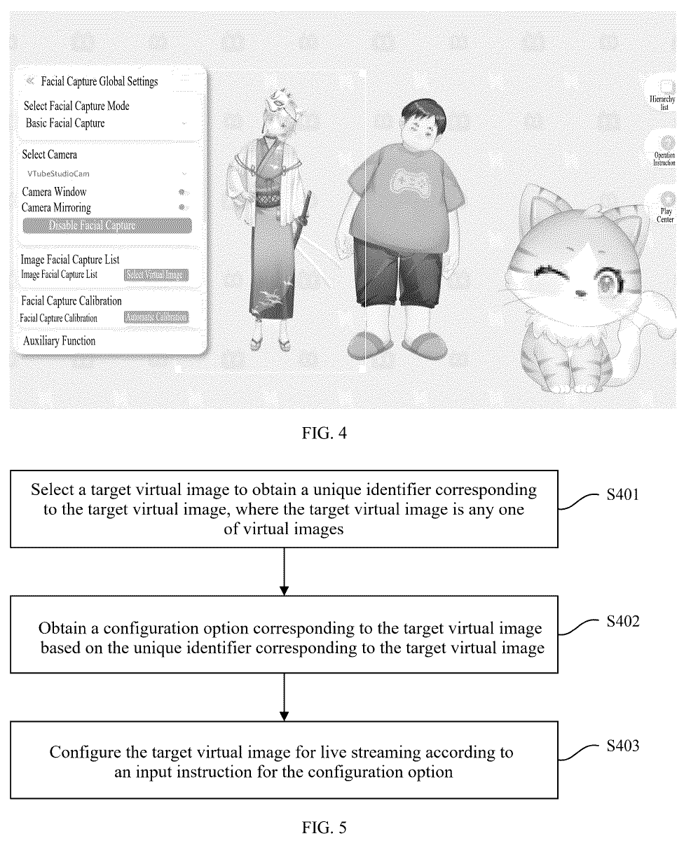

Referring to FIG. 4, when the streamer performs a motion of turning his/her head to the left, the virtual image also turns his/her head to the left based on the corresponding motion capture data, so as to implement a corresponding virtual live streaming effect. Certainly, in practical applications, other elements may also be added for the virtual live streaming according to requirements, such as a voice input of the streamer. Specific elements to be added are not limited herein.

In the virtual live streaming method provided in the embodiments of the present application, the at least two virtual images are loaded in the current live streaming room in response to the request for adding the at least two virtual images; the motion capture data for the current live streaming room is obtained; and virtual live streaming is performed in the current live streaming room based on the motion capture data and the virtual images. In this method, a plurality of virtual images can be loaded in a single live streaming room and virtual live streaming is performed by using the plurality of virtual images, thereby enriching implementation forms of virtual live streaming, and improving user experience in the live streaming room while reducing costs for virtual streamers to perform virtual live streaming using virtual live streaming technologies.

In an exemplary embodiment, after step S310, that is, after the virtual images are loaded in the current live streaming room, the method further includes: configuring each of the virtual images for live streaming. Correspondingly, in step S330, the performing virtual live streaming in the current live streaming room based on the motion capture data and the virtual images includes: performing virtual live streaming in the current live streaming room based on the motion capture data, the configuration for live streaming, and the virtual images.

Specifically, the streamer may perform an operation for the client 100, and the client 100 configures each of the virtual images for live streaming according to an input instruction corresponding to the operation of the streamer. After the configuration is completed, the client 100 performs virtual live streaming in the current live streaming room based on the obtained motion capture data, the configuration for live streaming, and the virtual images.

In this embodiment, each of the virtual images is configured for live streaming, and then the virtual live streaming is performed in the current live streaming room based on the motion capture data, the configuration for live streaming, and the virtual images. In this way, each of the virtual images may be specifically configured to meet usage requirements of the virtual streamers, thereby improving user experience.

In an exemplary embodiment, the configuring each of the virtual images for live streaming may include: configuring a different motion capture device for each of the virtual images, where the motion capture device is configured to obtain the motion capture data.

To be specific, there may be a plurality of motion capture devices 200 in FIG. 1. It may be understood that a different motion capture device (for example, a different camera) is configured for each of the virtual images, so that different virtual images may have different sources of the motion capture data, thereby implementing virtual live streaming in enriched forms. For example, there are a plurality of virtual streamers, and different motion capture devices are configured to capture motions of the different virtual streamers, and then different virtual images are driven for virtual live streaming based on the motions of different virtual streamers.

In an exemplary embodiment, as shown in FIG. 5, the configuring each of the virtual images for live streaming may include steps S401 to S403.

In step S401, a target virtual image is selected to obtain a unique identifier corresponding to the target virtual image, where the target virtual image is any one of the virtual images.

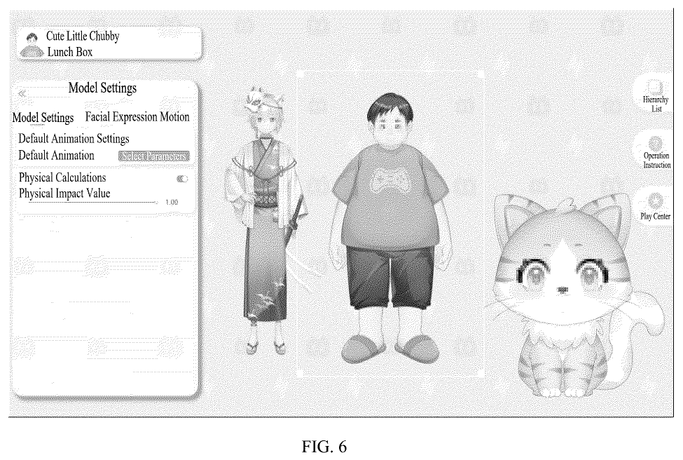

FIG. 6 is a diagram of an example of a scenario in which a virtual image is configured for live streaming. As shown in FIG. 6, if three virtual images are loaded by using live2d, the target virtual image may be selected according to an input instruction in an operation scene of live2d to obtain the unique identifier corresponding to the virtual image. For example, the virtual image in the middle of the figure may be selected to obtain the unique identifier of “Cute Little Chubby” corresponding to the virtual image.

In step S402, a configuration option corresponding to the target virtual image is obtained based on the unique identifier corresponding to the target virtual image.

As shown in FIG. 6, after the virtual image of “Cute Little Chubby” is selected, configuration options corresponding to the virtual image are displayed on the left, for example, configuration options for model settings and facial expression motion in the figure. It may be understood that the configuration options corresponding to “Cute Little Chubby” only take effect on the virtual image of “Cute Little Chubby” and do not take effect on other virtual images. Certainly, general configuration options may be configured for all virtual images. When the general configuration options are configured, the configuration takes effect on all virtual images. For example, as shown in FIG. 4, when the motion capture global settings are configured, the configuration takes effect on all virtual images. In addition, as shown in FIG. 4, the configuration options for global settings such as motion capture mode, camera, motion capture calibration, and auxiliary function may be configured accordingly. When the general configuration options are configured, any one of the virtual images may be selected to obtain corresponding general configuration options.

In step S403, the target virtual image is configured for live streaming according to an input instruction for the configuration option.

Specifically, the client 100 receives the input instruction from the virtual streamer for configuration options, and configures the target virtual image for live streaming according to the input instruction. The configuration for live streaming means a configuration related to live streaming. In a case that the virtual streamer can configure all configuration options, the configuration for live streaming may further include all configurations in virtual live streaming. Optionally, the configuration for live streaming may include: model settings, facial capture mode settings, camera settings, facial capture calibration, model sensitivity advanced settings, facial expression motions, and other configurations.

In this embodiment, the target virtual image is selected to obtain the unique identifier corresponding to the target virtual image; the configuration option corresponding to the target virtual image is obtained based on the unique identifier corresponding to the target virtual image; and the target virtual image is configured for live streaming according to the input instruction for the configuration option. Each of the virtual images may be configured according to actual requirements of the user, so that customization requirements of the user for the virtual image are met.

In an exemplary embodiment, in step S330, the performing virtual live streaming in the current live streaming room based on the motion capture data, the configuration for live streaming, and the virtual images includes: in a case that the configuration of the target virtual image for live streaming is updated, refreshing rendering of the target virtual image based on the motion capture data and the updated configuration for live streaming.

To be specific, the virtual streamer may update the configuration of the target virtual image for live streaming in real-time according to requirements. In a case that the client 100 determines that the configuration of the target virtual image for live streaming is updated, the client refreshes rendering of the target virtual image based on the motion capture data and the updated configuration for live streaming, so that the refreshed target virtual image matches the updated configuration for live streaming. Optionally, the virtual streamer may alternatively update the configuration of the target virtual image for live streaming during initial configuration of the virtual image. The rendering of the target virtual image is refreshed, so that the virtual streamer can visually see an effect of the updated configuration for live streaming.

In this embodiment, in a case that the configuration of the target virtual image for live streaming is updated, the rendering of the target virtual image is refreshed based on the motion capture data and the updated configuration for live streaming, so that the virtual streamer can visually see an effect of the updated configuration for live streaming.

In an exemplary embodiment, the configuration for live streaming includes a configuration for a facial expression, and the configuration for a facial expression is used to drive the virtual image to make a preset facial expression motion according to a preset instruction. In step S330, virtual live streaming is performed in the current live streaming room based on the motion capture data, the configuration for live streaming, and the virtual images. In a case that the target virtual image is configured with the facial expression and the preset instruction is received, the target virtual image is driven to make the preset facial expression motion, where the target virtual image is any one or more of the virtual images.

The preset facial expression motion may be determined based on a resource in the virtual live streaming technology. This is not limited herein. For example, the preset facial expression motion includes switching the target virtual image to a preset virtual image.

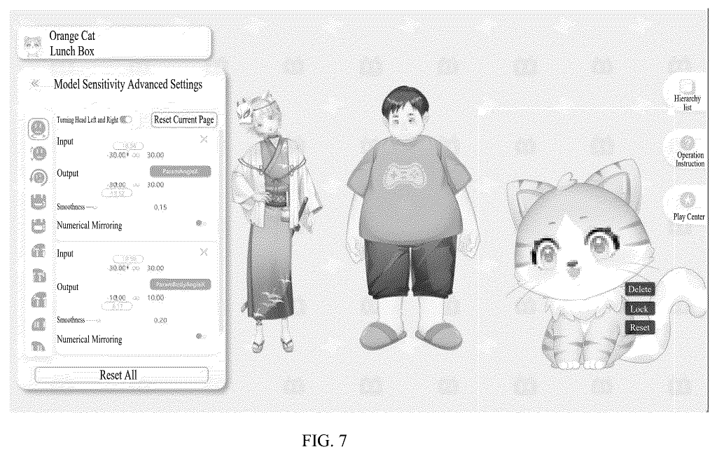

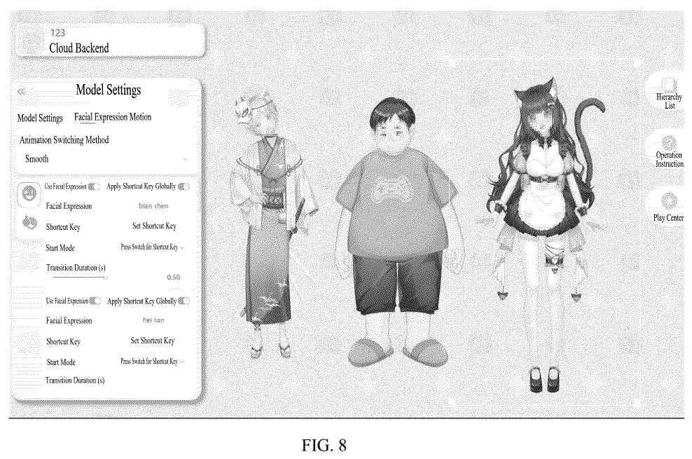

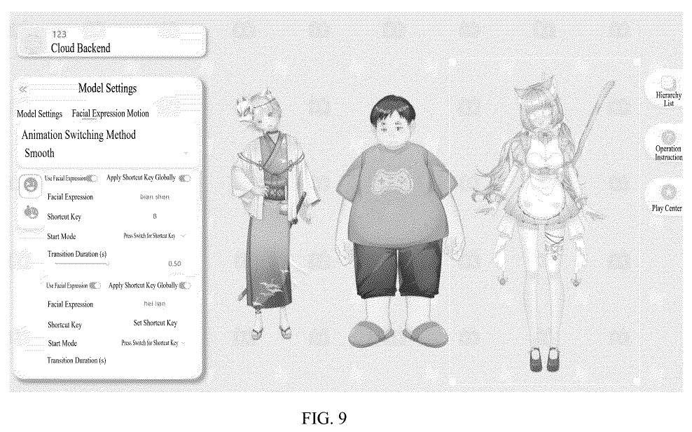

For example, as shown in FIG. 7, a virtual image of “Orange Cat” may be configured for live streaming accordingly. As shown in FIG. 8, if the virtual image of “Orange Cat” is configured with a facial expression of “bian shen”, the virtual image switches from the “Orange Cat” to a preset virtual image upon receiving a preset instruction corresponding to a shortcut key. For example, as shown in FIG. 9, if the virtual image is configured with another facial expression of “hei lian”, the virtual image make a preset facial expression motion of unpleasant upon receiving a preset instruction corresponding to a shortcut key.

In this embodiment, in a case that the target virtual image is configured with the facial expression and the preset instruction is received, the target virtual image is driven to make the preset facial expression motion. Because the virtual image may be used to perform more facial expression motions in virtual live streaming based on the configuration for a facial expression, representations of virtual live streaming may be further enriched.

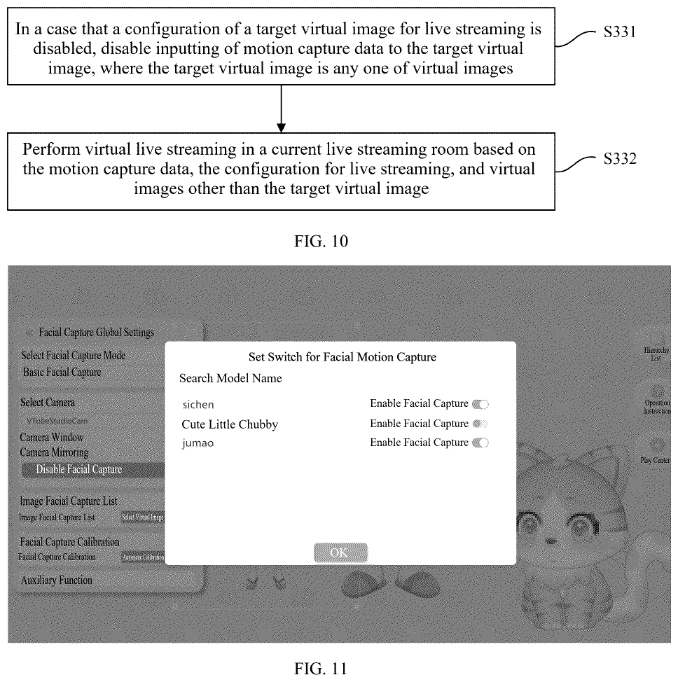

In an exemplary embodiment, the configuration for live streaming is used to enable or disable inputting of the motion capture data to the virtual image. The performing virtual live streaming in the current live streaming room based on the motion capture data, the configuration for live streaming, and the virtual images in step S330, as shown in FIG. 10, may include steps S331 and S332, which are specifically as follows.

In step S331, in a case that the configuration of the target virtual image for live streaming is disabled, inputting of the motion capture data to the target virtual image is disabled, where the target virtual image is any one of the virtual images.

Specifically, in a case that the configuration of the target virtual image for live streaming is enabled, the motion capture data is normally inputted into the target virtual image to drive the target virtual image to make a facial expression motion corresponding to the motion capture data. In a case that the configuration of the target virtual image for live streaming is disabled, the motion capture data is not inputted into the target virtual image. In this case, the target virtual image does not make a facial expression motion corresponding to the motion capture data.

In step S332, virtual live streaming is performed in the current live streaming room based on the motion capture data, the configuration for live streaming, and virtual images other than the target virtual image.

It may be understood that although the inputting of the motion capture data has been disabled for the target virtual image, the inputting of the motion capture data has not been disabled for other virtual images. Therefore, the motion capture data can still drive the other virtual images to make a corresponding facial expression motion for virtual live streaming.

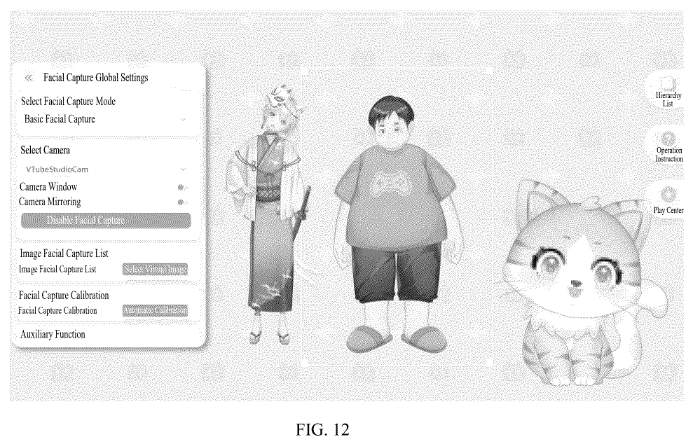

For example, as shown in FIG. 11, the configuration of the virtual image of “Cute Little Chubby” for live streaming may be disabled. Correspondingly, as shown in FIG. 12, the virtual image of “Cute Little Chubby” no longer makes the corresponding facial expression motion (turning his/her head to the left) based on the motion capture data while the other virtual images still make the corresponding facial expression motion based on the motion capture data. It should be noted that FIG. 11 and FIG. 12 only show a case in which one virtual image is disabled. In fact, there may be two or more target virtual images, that is, the inputting of the motion capture data is disabled for two or more virtual images.

In this embodiment, in a case that the configuration of the target virtual image for live streaming is disabled, the inputting of the motion capture data to the target virtual image is disabled, and virtual live streaming is performed in the current live streaming room based on the motion capture data, the configuration for live streaming, and virtual images other than the target virtual image. In this way, the virtual streamer can disable a virtual image according to requirements, thereby further enriching the expressions of live streaming by loading a plurality of virtual images in a single live streaming room.

To clearly describe the virtual live streaming method in the embodiments of the present application, a specific example is used for description below.

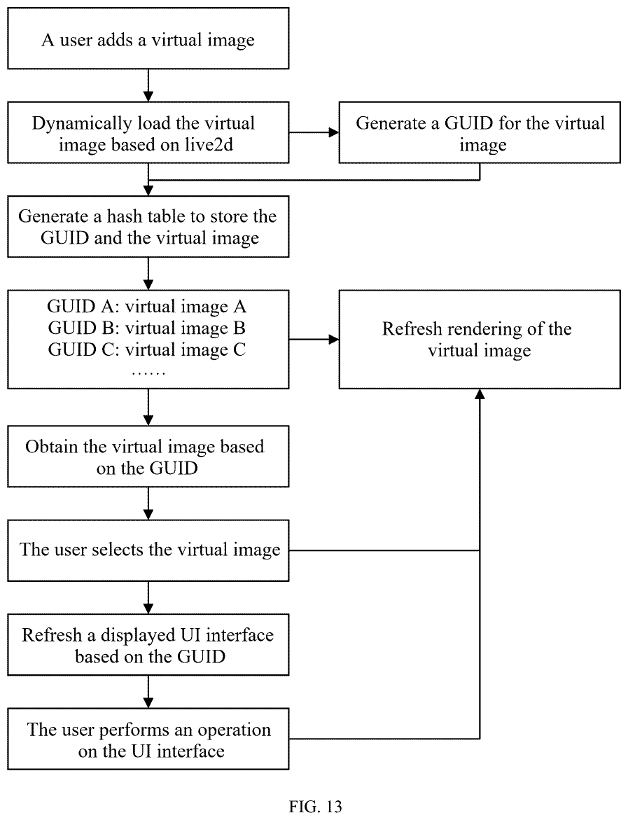

FIG. 13 is an example flowchart of a virtual live streaming method, and procedures thereof are generally as follows.
1. A user adds a virtual image.
2. The virtual image is dynamically loaded based on live2d and a GUID is generated for the virtual image.
3. A hash table is generated to store the GUID and the virtual image. For example, a GUID A corresponds to a virtual image A, a GUID B corresponds to a virtual image B, a GUID C corresponds to a virtual image C, and so on. In this case, rendering of the virtual image may be refreshed.
4. The virtual image is obtained based on the GUID.
5. The user selects the virtual image. In this case, the rendering of the virtual image may be refreshed.
6. A displayed UI interface is refreshed based on the GUID.
7. The user performs an operation on the UI interface. In this case, the rendering of the virtual image is refreshed.

### Embodiment 2

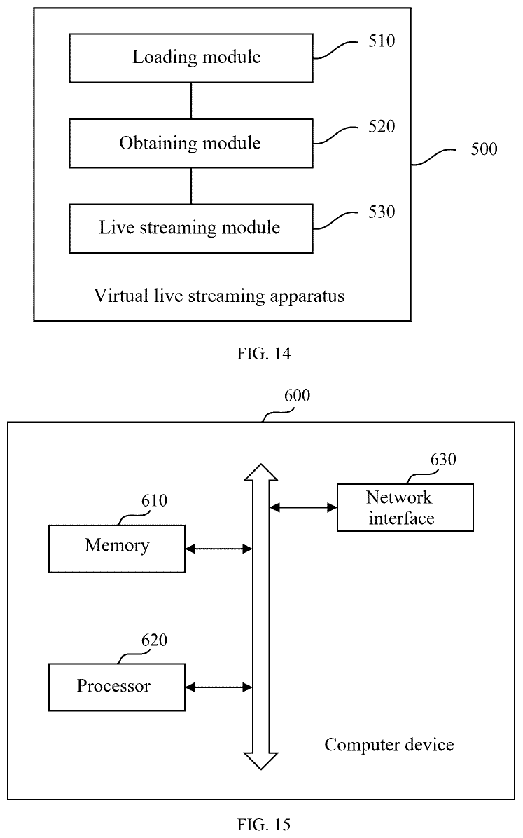

FIG. 14 is a block diagram schematically showing a virtual live streaming apparatus 500 according to Embodiment 2 of the present application. The virtual live streaming apparatus 500 may be divided into one or more program modules, which are stored in a storage medium and executed by one or more processors to complete the embodiments of the present application. The program modules in this embodiment of the present application refer to a series of computer program instruction segments that can complete a specific function. The functions of the program modules in this embodiment are specifically described in the following description.

As shown in FIG. 14, the virtual live streaming apparatus 500 may include a loading module 510, an obtaining module 520, and a live streaming module 530.

The load module 510 is configured to: in response to a request for adding at least two virtual images, load the virtual images in a current live streaming room.

The obtaining module 520 is configured to obtain motion capture data for the current live streaming room.

The live streaming module 530 is configured to perform virtual live streaming in the current live streaming room based on the motion capture data, the configuration for live streaming, and the virtual images.

In an exemplary embodiment, the virtual live streaming apparatus 500 further includes a configuration module (not shown in the figure), and the configuration module is configured to configure each of the virtual images for live streaming. The live streaming module 530 is further configured to perform virtual live streaming in the current live streaming room based on the motion capture data, the configuration for live streaming, and the virtual images.

In an exemplary embodiment, the configuration module is further configured to configure a different motion capture device for each of the virtual images, where the motion capture device is configured to obtain the motion capture data.

In an exemplary embodiment, the loading module 510 is further configured to: generate a unique identifier corresponding to each of the virtual images when the virtual image is loaded; and store each of the virtual images and the unique identifier corresponding to the virtual image by using a hash table.

In an exemplary embodiment, the configuration module is further configured to select a target virtual image to obtain the unique identifier corresponding to the target virtual image, where the target virtual image is any one of the virtual images; obtain a configuration option corresponding to the target virtual image based on the unique identifier corresponding to the target virtual image; and configure the target virtual image for live streaming based on an input instruction for the configuration option.

In an exemplary embodiment, the live streaming module 530 is further configured to: in a case that the configuration of the target virtual image for live streaming is updated, refresh rendering of the target virtual image based on the motion capture data and the updated configuration for live streaming.

In an exemplary embodiment, the configuration for live streaming includes configuration for a facial expression, and the configuration for a facial expression is used to drive the virtual image to make a preset facial expression motion according to a preset instruction. The live streaming module 530 is further configured to: in a case that the target virtual image is configured with the facial expression and the preset instruction is received, drive the target virtual image to make the preset facial expression motion, where the target virtual image is any one or more of the virtual images.

In an exemplary embodiment, the preset facial expression motion includes switching the target virtual image to a preset virtual image.

In an exemplary embodiment, the configuration for live streaming is used to enable or disable inputting of the motion capture data to the virtual image. The live streaming module 530 is further configured to: in a case that the configuration of the target virtual image for live streaming is disabled, disable the inputting of the motion capture data to the target virtual image, where the target virtual image is any one of the virtual images; and perform virtual live streaming in the current live streaming room based on the motion capture data, the configuration for live streaming, and virtual images other than the target virtual image.

### Embodiment 3

FIG. 15 is a diagram schematically showing a hardware architecture of a computing device 600 that is applicable to a virtual live streaming method according to Embodiment 3 of the present application. The computing device 600 may be a device that can automatically perform numerical calculations and/or data processing based on preset or prestored instructions. For example, the computing device may be a rack server, a blade server, a tower server, or a cabinet server (including an independent server or a server cluster composed of a plurality of servers), a gateway, etc. As shown in FIG. 15, the computing device 600 at least includes, but is not limited to: a memory 610, a processor 620, and a network interface 630 that may be communicatively linked to each other by using a system bus.

The memory 610 includes at least one type of computer-readable storage medium, including a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 610 may be an internal storage module of the computing device 600, for example, a hard disk or memory of the computing device 600. In some other embodiments, the memory 610 may alternatively be an external storage device of the computing device 600, for example, a plug-in type hard disk equipped on the computing device 600, a smart media card (SMC for short), a secure digital (SD for short) card, or a flash card. Certainly, the memory 610 may alternatively include both the internal storage module of the computing device 600 and the external storage device of the computing device. In this embodiment, the memory 610 is generally configured to store an operating system and various types of application software installed on the computing device 600, such as program code for the virtual live streaming method. In addition, the memory 610 may be further configured to temporarily store various types of data that have been output or are to be output.

The processor 620 may be, in some embodiments, a central processing unit (CPU for short), a controller, a microcontroller, a microprocessor, or other data processing chips. The processor 620 is generally configured to control overall operation of the computing device 600, for example, execute control, processing, and the like related to data interaction or communication with the computing device 600. In this embodiment, the processor 620 is configured to run program code stored in the memory 610 or to process data.

The network interface 630 may include a wireless network interface or a wired network interface. The network interface 630 is generally configured to establish a communication link between the computing device 600 and other computing devices. For example, the network interface 630 is configured to connect the computing device 600 to an external terminal by using a network, and establish a data transmission channel, a communication link, and the like between the computing device 600 and the external terminal. The network may be a wireless or wired network such as Intranet, Internet, a Global System for Mobile Communications (GSM for short), Wideband Code Division Multiple Access (WCDMA for short), a 4G network, a 5G network, Bluetooth, or Wi-Fi.

It should be noted that FIG. 15 shows only a computing device having components 610 to 630, but it should be understood that not all of the illustrated components are required to be implemented, and more or fewer components may be implemented instead.

In this embodiment, the virtual live streaming method stored in the memory 610 may alternatively be divided into one or more program modules and executed by one or more processors (the processor 620 in this embodiment) to implement the embodiments of the present application.

### Embodiment 4

An embodiment of the present application further provides a computer-readable storage medium, where the computer-readable storage medium stores a computer program that, when executed by a processor, implements the steps of the virtual live streaming method in this embodiment.

In this embodiment, the computer-readable storage medium includes a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the computer-readable storage medium may be an internal storage unit of the computing device, for example, a hard disk or memory of the computing device. In some other embodiments, the computer-readable storage medium may alternatively be an external storage device of the computing device, for example, a plug-in type hard disk equipped on the computing device, a smart media card (SMC for short), a secure digital (SD for short) card, or a flash card. Certainly, the computer-readable storage medium may alternatively include both the internal storage unit of the computing device and the external storage device of the computing device. In this embodiment, the computer-readable storage medium is typically used to store an operating system and various application software that are installed on a computing device, for example, program code for the virtual live streaming method in this embodiment. In addition, the computer-readable storage medium may be configured to temporarily store various types of data that have been output or are to be output.

It is apparent to those skilled in the art that the various modules or steps in the above embodiments of the present application may be implemented by a general-purpose computing apparatus, and may be centralized on a single computing apparatus or distributed on a network formed by a plurality of computing apparatuses. Optionally, the various modules or steps may be implemented by using program code executable by the computing apparatus, such that they may be stored in a storage apparatus and executed by the computing apparatus, and in some cases, the steps shown or described may be performed in a sequence different from that described herein, or they may be respectively fabricated into various integrated circuit modules, or a plurality of modules or steps thereof may be implemented as a single integrated circuit module. In this way, the embodiments of the present application are not limited to any specific combination of hardware and software.

The above descriptions are merely preferred embodiments of the present application, and are not intended to limit the patent scope of the present application. Any transformation of equivalent structures or equivalent processes that is made using the contents of the description and accompanying drawings of the present application, or any direct or indirect application thereof in other related technical fields shall equally fall within the patent protection scope of the present application.

What is claimed is:

1. A method for live streaming using virtual images, comprising:
loading at least two virtual images in a current live streaming room in response to a request for adding the at least two virtual images;
generating a unique identifier corresponding to each of the at least two virtual images while loading each of the at least two virtual images;
obtaining motion capture data indicative of motions to be applied in the current live streaming room; and
performing virtual live streaming in the current live streaming room based on the at least two virtual images and the motion capture data.

2. The method according to claim 1, further comprising:
configuring different motion capture devices for the at least two virtual images, wherein each of the different motion capture devices is configured to obtain motion capture data corresponding to each of the least two virtual images.

3. The method according to claim 1, further comprising:
storing each of the at least two virtual images and the unique identifier corresponding to each of the at least two virtual images by using a hash table.

4. The method according to claim 1, further comprising:
configuring each of the at least two virtual images by performing live streaming configuration on each of the at least two virtual images; and
performing the virtual live streaming in the current live streaming room based on the at least two virtual images, the motion capture data, and the live streaming configuration.

5. The method according to claim 4, wherein the configuring each of the at least two virtual images further comprises:
selecting a target virtual image and obtaining a unique identifier of the target virtual image, wherein the target virtual image is any one of the at least two virtual images;
obtaining at least one configuration option corresponding to the target virtual image based on the unique identifier of the target virtual image; and
configuring the target virtual image based on an input instruction corresponding to the at least one configuration option.

6. The method according to claim 5, further comprising:
in response to determining that a configuration of the target virtual image is updated, refreshing rendering of the target virtual image based on motion capture data and updated configuration corresponding to the target virtual image.

7. The method according to claim 4, wherein the live streaming configuration comprises a facial expression configuration, wherein the facial expression configuration is configured to drive a corresponding virtual image among the at least two virtual images to perform a preset facial expression motion based on a preset instruction, and wherein the method further comprises:
driving a target virtual image to perform the preset facial expression motion in response to determining that the target virtual image is configured with the facial expression configuration and that the preset instruction is received, wherein the target virtual image is any one of the at least two virtual images.

8. The method according to claim 7, wherein the preset facial expression motion comprises switching the target virtual image to a preset virtual image.

9. The method according to claim 4, wherein the live streaming configuration is configured to enable or disable input of motion capture data to a corresponding virtual image among the least two virtual images, and wherein the method further comprises:
disabling input of motion capture data to a target virtual image in response to determining that a live streaming configuration of the target virtual image is disabled, wherein the target virtual image is any one of the at least two virtual images; and
performing the virtual live streaming in the current live streaming room based on the motion capture data, the live streaming configuration, and at least one other virtual image than the target virtual image.

10. A computing device, comprising a memory and a processor, wherein the memory stores computer-readable instructions that upon execution by the processor cause the processor to perform operations comprising:
loading at least two virtual images in a current live streaming room in response to a request for adding the at least two virtual images;
generating a unique identifier corresponding to each of the at least two virtual images while loading each of the at least two virtual images;
obtaining motion capture data indicative of motions to be applied in the current live streaming room; and
performing virtual live streaming in the current live streaming room based on the at least two virtual images and the motion capture data.

11. The computing device according to claim 10, the operations further comprising:
configuring different motion capture devices for the at least two virtual images, wherein each of the different motion capture devices is configured to obtain motion capture data corresponding to each of the least two virtual images.

12. The computing device according to claim 10, the operations further comprising:
storing each of the at least two virtual images and the unique identifier corresponding to each of the at least two virtual images by using a hash table.

13. The computing device according to claim 10, the operations further comprising:
configuring each of the at least two virtual images by performing live streaming configuration on each of the at least two virtual images; and
performing the virtual live streaming in the current live streaming room based on the at least two virtual images, the motion capture data, and the live streaming configuration.

14. The computing device according to claim 13, wherein the configuring each of the at least two virtual images further comprises:
selecting a target virtual image and obtaining a unique identifier of the target virtual image, wherein the target virtual image is any one of the at least two virtual images;
obtaining at least one configuration option corresponding to the target virtual image based on the unique identifier of the target virtual image; and
configuring the target virtual image based on an input instruction corresponding to the at least one configuration option.

15. The computing device according to claim 13, wherein the live streaming configuration comprises a facial expression configuration, wherein the facial expression configuration is configured to drive a corresponding virtual image among the at least two virtual images to perform a preset facial expression motion based on a preset instruction, and wherein the operations further comprise:
driving a target virtual image to perform the preset facial expression motion in response to determining that the target virtual image is configured with the facial expression configuration and that the preset instruction is received, wherein the target virtual image is any one of the at least two virtual images.

16. The computing device according to claim 13, wherein the live streaming configuration is configured to enable or disable input of motion capture data to a corresponding virtual image among the least two virtual images, and wherein the operations further comprise:
disabling input of motion capture data to a target virtual image in response to determining that a live streaming configuration of the target virtual image is disabled, wherein the target virtual image is any one of the at least two virtual images; and
performing the virtual live streaming in the current live streaming room based on the motion capture data, the live streaming configuration, and at least one other virtual image than the target virtual image.

17. A non-transitory computer-readable storage medium, storing computer-readable instructions that upon execution by a processor cause the processor to implement operations comprising:
loading at least two virtual images in a current live streaming room in response to a request for adding the at least two virtual images;
generating a unique identifier corresponding to each of the at least two virtual images while loading each of the at least two virtual images;
obtaining motion capture data indicative of motions to be applied in the current live streaming room; and
performing virtual live streaming in the current live streaming room based on the at least two virtual images and the motion capture data.

18. The non-transitory computer-readable storage medium according to claim 17, the operations further comprising:
configuring different motion capture devices for the at least two virtual images, wherein each of the different motion capture devices is configured to obtain motion capture data corresponding to each of the least two virtual images.

19. The non-transitory computer-readable storage medium according to claim 17, the operations further comprising:
configuring each of the at least two virtual images by performing live streaming configuration on each of the at least two virtual images; and
performing the virtual live streaming in the current live streaming room based on the at least two virtual images, the motion capture data, and the live streaming configuration.

20. The non-transitory computer-readable storage medium according to claim 19, wherein the live streaming configuration is configured to enable or disable input of motion capture data to a corresponding virtual image among the least two virtual images, and wherein the operations further comprise:
disabling input of motion capture data to a target virtual image in response to determining that a live streaming configuration of the target virtual image is disabled, wherein the target virtual image is any one of the at least two virtual images; and
performing the virtual live streaming in the current live streaming room based on the motion capture data, the live streaming configuration, and at least one other virtual image than the target virtual image.
